(19) United States
(12) Patent Application Publication
(10) Pub. No.: US 2025/0271697 A1
(43) Pub. Date: Aug. 28, 2025

(54) METHOD OF FABRICATING COLOR FILTER SUBSTRATE

(71) Applicant: HannStar Display Corporation, Taipei City (TW)

(72) Inventors: Shao-Chien Chang, Taipei City (TW); Cheng-Yen Yeh, Taipei City (TW); Ling Chih Kao, Taipei City (TW); Ying-Jung Chen, Taipei City (TW); Jing-Ya Chiu, Taipei City (TW); Qi-En Luo, Taipei City (TW)

(73) Assignee: HannStar Display Corporation, Taipei City (TW)

(21) Appl. No.: 18/894,021

(22) Filed: Sep. 24, 2024

Related U.S. Application Data
(60) Provisional application No. 63/558,091, filed on Feb. 26, 2024.

(51) Int. Cl. G02F 1/1335

(52) U.S. Cl. CPC G02F 1/133516; G02F 1/133519

(57) ABSTRACT

A method of fabricating a color filter substrate including forming a color filter layer on a substrate, forming at least one overcoat material layer, performing an exposure step on the at least one overcoat material layer by using a mask and performing a development step to remove a portion of the at least one overcoat material layer and form an overcoat layer having a flat portion, a first protruding portion and a second protruding portion is provided. The mask has a first light-transmitting area and a second light-transmitting area. The transmittance of the first light-transmitting area is greater than the transmittance of the second light-transmitting area. The flat portion, the first protruding portion and the second protruding portion of the overcoat layer respectively have different heights relative to a substrate surface of the substrate.

### CROSS-REFERENCE TO RELATED APPLICATION

This application claims the priority benefit of U.S. provisional application Ser. No. 63/558,091, filed on Feb. 26, 2024. The entirety of the above-mentioned patent application is hereby incorporated by reference herein and made a part of this specification.

### BACKGROUND

### Technical Field

The disclosure relates to a method for fabricating a substrate, and in particular, to a method for fabricating a color filter substrate.

### Description of Related Art

In current liquid crystal displays, an overcoat layer and spacers on a color filter substrate are made of two different materials. However, this approach is not only more costly but also time-consuming. It is even more difficult to improve the material bonding quality at the interface between the overcoat layer and the spacers made of different materials.

### SUMMARY

The disclosure provides a method for fabricating a color filter substrate, characterized by a reduced number of process steps and fewer types of materials used, and the produced film structure is less susceptible to damage from external forces.

A method of fabricating a color filter substrate includes forming a color filter layer on a substrate, forming at least one overcoat material layer on the color filter layer, performing an exposure step on the at least one overcoat material layer using a mask and performing a development step to remove part of the at least one overcoat material layer and form an overcoat layer having a flat portion, a first protruding portion and a second protruding portion. The mask has a first light-transmitting area and a second light-transmitting area. A transmittance of the first light-transmitting area is greater than a transmittance of the second light-transmitting area. The flat portion, the first protruding portion and the second protruding portion of the overcoat layer respectively have different heights relative to a substrate surface of the substrate.

In an embodiment of the disclosure, the at least one overcoat material layer is an overcoat material layer. The mask further has a light-shielding area in addition to the first light-transmitting area and the second light-transmitting area. The overcoat material layer has a portion overlapping the light-shielding area. The portion of the overcoat material layer forms the flat portion after the exposure step and the development step are completed.

In an embodiment of the disclosure, the method of fabricating the color filter substrate further includes performing a baking step on the overcoat material layer after the exposure step and before the development step.

In an embodiment of the disclosure, the method of fabricating the color filter substrate further includes performing another exposure step on the entire overcoat material layer before performing the exposure step on the overcoat material layer using the mask. The exposure intensity of the another exposure step is lower than the exposure intensity of the exposure step.

In an embodiment of the disclosure, the method of fabricating the color filter substrate further includes performing a baking step on the overcoat material layer after the exposure step and the another exposure step are completed.

In an embodiment of the disclosure, the step of forming the at least one overcoat material layer includes forming a first overcoat material layer on the color filter layer. The method of fabricating the color filter substrate further includes performing another exposure step on the entire first overcoat material layer to form the flat portion.

In an embodiment of the disclosure, the step of forming the at least one overcoat material layer further includes forming a second overcoat material layer on the flat portion after the another exposure step is completed. The second overcoat material layer forms the first protruding portion and the second protruding portion after the exposure step and the development step.

In an embodiment of the disclosure, a baking step is performed on the first overcoat material layer after the another exposure step is completed and before the second overcoat material layer is formed.

In an embodiment of the disclosure, the at least one overcoat material layer is an overcoat material layer. The mask further has a third light-transmitting area. A transmittance of the third light-transmitting area is less than the transmittance of the first light-transmitting area and the transmittance of the second light-transmitting area. The overcoat material layer has a portion overlapping the third light-transmitting area. The portion of the overcoat material layer forms the flat portion of the overcoat layer after the exposure step and the development step are completed.

In an embodiment of the disclosure, the at least one overcoat material layer is a negative photoresist.

Based on the above, in a method of fabricating a color filter substrate according to an embodiment of the disclosure, an exposure step using a mask having at least two light-transmitting areas is performed on one of the at least one overcoat material layer formed on a color filter layer, and an overcoat layer having multiple portions of different heights is formed after a development step. Accordingly, in addition to simplifying the manufacture process of the color filter substrate, the variety of materials used may be reduced. The multiple portions of the produced overcoat layer with different heights may fulfill various functional requirements and are less susceptible to damage from external forces.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a flow chart of a method of fabricating a color filter substrate according to a first embodiment of the disclosure.

FIGS. 2A to 2F are schematic cross-sectional views of a method of fabricating a color filter substrate according to a first embodiment of the disclosure.

FIG. 3 is a flow chart of a method of fabricating a color filter substrate according to a second embodiment of the disclosure.

FIGS. 4A to 4H are schematic cross-sectional views of a method of fabricating a color filter substrate according to a second embodiment of the disclosure.

FIG. 5 is a flow chart of a method of fabricating a color filter substrate according to a third embodiment of the disclosure.

FIGS. 6A to 6G are schematic cross-sectional views of a method of fabricating a color filter substrate according to a third embodiment of the disclosure.

FIG. 7 is a flow chart of a method of fabricating a color filter substrate according to a fourth embodiment of the disclosure.

FIGS. 8A to 8F are schematic cross-sectional views of a method of fabricating a color filter substrate according to a fourth embodiment of the disclosure.

### DESCRIPTION OF THE EMBODIMENTS

The aforementioned technical contents, features and effects of the present invention will be clearly presented in the following detailed description of a preferred embodiment with reference to the drawings. The directional terms used in the following embodiments, such as up, down, left, right, front, or rear, are for reference to the directions indicated in the accompanying drawings. Therefore, these directional terms are used for explanation purposes and not for limiting the scope of the invention.

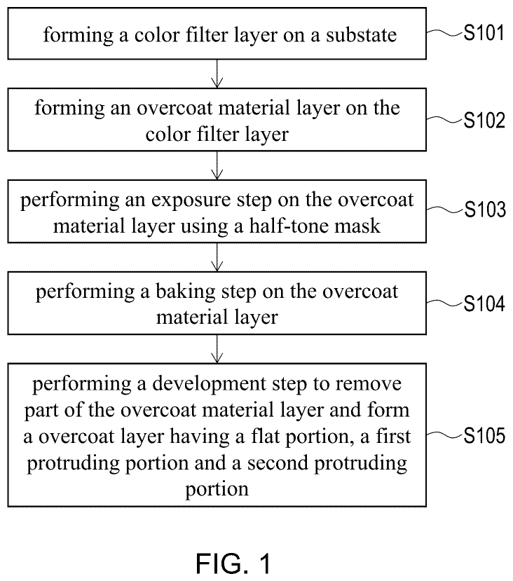

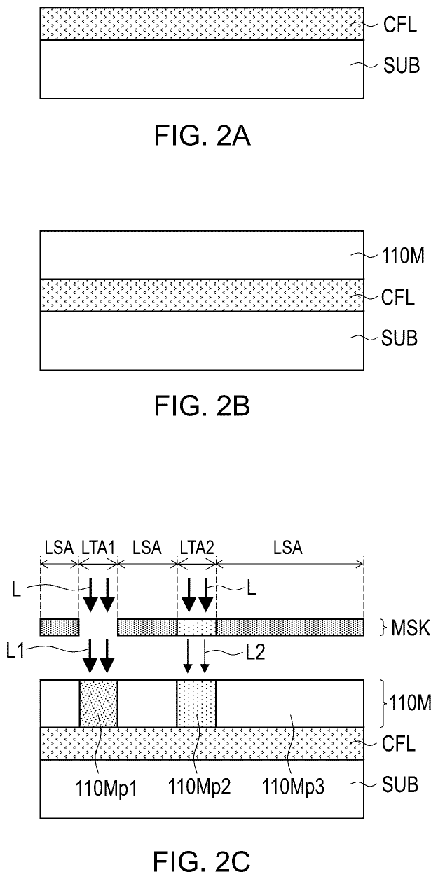

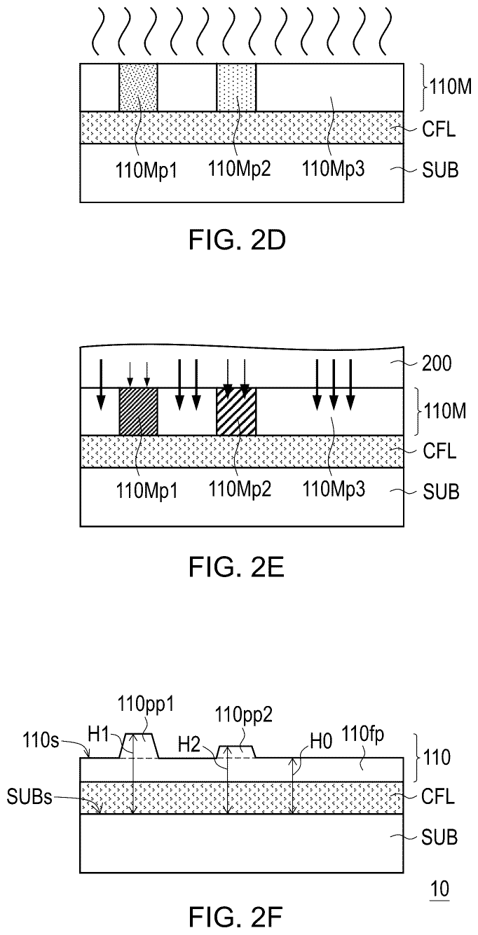

FIG. 1 is a flow chart of a method of fabricating a color filter substrate according to a first embodiment of the disclosure. FIGS. 2A to 2F are schematic cross-sectional views of a method of fabricating a color filter substrate according to a first embodiment of the disclosure. Referring to FIG. 2F, a color filter substrate 10 includes a substrate SUB, a color filter layer CFL and an overcoat layer 110. The color filter layer CFL is disposed on a substrate surface SUBs of the substrate SUB. The overcoat layer 110 is disposed on the color filter layer CFL and has a flat portion 110fp, a first protruding portion 110pp1 and a second protruding portion 110pp2. The first protruding portion 110pp1 and the second protruding portion 110pp2 respectively protrude from a surface 110s of the flat portion 110fp facing away from the color filter layer CFL.

More specifically, the flat portion 110fp, the first protruding portion 110pp1 and the second protruding portion 110pp2 of the overcoat layer 110 respectively have a height H0, a height H1 and a height H2 relative to the substrate surface SUBs of the substrate SUB, and these heights are different from each other. For example, in the embodiment, the height H2 of the second protruding portion 110pp2 of the overcoat layer 110 is greater than the height H0 of the flat portion 110fp and less than the height H1 of the first protruding portion 110pp1.

Although the number of the first protruding portion 110pp1 and the second protruding portion 110pp2 in FIG. 2F is exemplified by taking one as an example, it can be understood that the overcoat layer 110 on the color filter substrate 10 may have a plurality of first protruding portions 110pp1 and a plurality of second protruding portions 110pp2.

In particular, the color filter substrate 10, a pixel array substrate (no shown) and a liquid crystal layer (not shown) of the embodiment are suitable for being assembled into a liquid crystal display panel, where the liquid crystal layer is sandwiched between the pixel array substrate and the color filter substrate 10. The color filter layer CFL on the color filter substrate 10 may include a plurality of filter patterns (not shown), and these filter patterns are suitable for allowing various colors of light (such as red light, green light and blue light, but the disclosure is not limited thereto) to pass through respectively, so that the liquid crystal display panel can display colors.

On the other hand, the first protruding portion 110pp1 and the second protruding portion 110pp2 on the color filter substrate 10 may respectively serve as a main spacer and a sub spacer for controlling a thickness of the liquid crystal layer, but the disclosure is not limited thereto. Firstly, it should be noted that since the first protruding portion 110pp1 and the second protruding portion 110pp2 of the overcoat layer 110 function as traditional spacers, the variety of materials used in the color filter substrate 10 may be significantly reduced. In addition, since the first protruding portion 110pp1 and the second protruding portion 110pp2 serving as the spacers and the flat portion 110fp covering the color filter layer CFL are integrated (i.e., made of the same material), in comparison to traditional method where the spacer and the overcoat layer are made of two different materials, the material bonding quality at the interface between the protruding portion and the flat portion 110fp in the embodiment may be significantly improved.

A fabricating method of the color filter substrate 10 will be exemplarily described below.

Referring to FIG. 1 and FIG. 2A, first, forming a color filter layer CFL on a substrate SUB (i.e. step S101). Next, forming an overcoat material layer 110M on the color filter layer CFL (i.e., step S102), as shown in FIG. 2B. Specifically, in the embodiment, a thickness of the overcoat material layer 110M is greater than the sum of thicknesses of the first protruding portion 110pp1 and the flat portion 110fp in FIG. 2F. The thickness referred to here, for example, is the thickness along the stacking direction of the substrate SUB and the color filter layer CFL. More specifically, in the method of fabricating the color filter substrate 10 of the embodiment, the step of forming the overcoat material layer 110M may be a one-time coating method, but the disclosure is not limited thereto.

Referring to FIG. 1 and FIG. 2C, after the film formation of the overcoat material layer 110M, performing an exposure step on the overcoat material layer 110M using a mask MSK (i.e., step S103). In the embodiment, the mask MSK is, for example, a half-tone mask, which may have a first light-transmitting area LTA1, a second light-transmitting area LTA2 and a light-shielding area LSA outside the first light-transmitting area LTA1 and the second light-transmitting area LTA2. For example, a transmittance of the first light-transmitting area LTA1 is greater than a transmittance of the second light-transmitting area LTA2, and a transmittance of the light-shielding area LSA is zero. Therefore, during the exposure process, the multiple light rays L emitted by an exposure light source form a light ray L1 and a light ray L2 with different light intensities after respectively passing through the first light-transmitting area LTA1 and the second light-transmitting area LTA2 of the mask MSK. For example, after passing through the mask MSK, the light intensity of the light ray L1 is greater than the light intensity of the light ray L2.

After the exposure step is completed, the portion 110Mp1 of the overcoat material layer 110M irradiated by the light ray L1 (i.e., the portion overlapping the first light-transmitting area LTA1 of the mask MSK) will have a higher degree of cure than the portion 110Mp2 of the overcoat material layer 110M irradiated by the light ray L2 (i.e., the portion overlapping the second light-transmitting area LTA2 of the mask MSK), and the portion 110Mp3 of the overcoat material layer 110M that is not irradiated by the light ray (i.e., the portion overlapping the light-shielding area LSA of the mask MSK) will not be substantially cured.

Referring to FIG. 1 and FIG. 2D, after the exposure step of the overcoat material layer 110M, performing a baking step on the overcoat material layer 110M (i.e., step S104). During the baking process, the overall material bonding strength of the entire overcoat material layer 110M may be further improved. Next, performing a development step to remove part of the overcoat material layer 110M, and form an overcoat layer 110 having a flat portion 110fp, a first protruding portion 110pp1 and a second protruding portion 110pp2 (i.e., step S105).

As shown in FIG. 2E and FIG. 2F, during the development process, the action depth of a developer 200 on the overcoat material layer 110M will depend on the degree of cure of each portion of the overcoat material layer 110M during the exposure process. For example, the portion 110Mp1 of the overcoat material layer 110M with the highest degree of cure is the least likely to be washed away by the developer 200, the portion 110Mp3 with the lowest degree of cure is most likely to be washed away by the developer 200, and the portion 110Mp2, which has the degree of cure between the portion 110Mp1 and the portion 110Mp3, will have an extent of washing away that is between the above two.

That is to say, after the development step is completed, the portion 110Mp1 of the overcoat material layer 110M with the highest degree of cure remains the most and forms the first protruding portion 110pp1 of the overcoat layer 110. The portion 110Mp2 of the overcoat material layer 110M with the second highest degree of cure remains the second most and forms the second protruding portion 110pp2 of the overcoat layer 110. The portion 110Mp3 of the overcoat material layer 110M with the lowest degree of cure remains the least and forms the flat portion 110fp of the overcoat layer 110. According to the height of each portion of the overcoat layer 110 relative to the substrate surface SUBs, the order from large to small is the first protruding portion 110pp1, the second protruding portion 110pp2 and the flat portion 110fp. Specifically, the depth and rate of development may be controlled by adjusting the concentration of the developer 200. That is, the thickness of each portion of the overcoat layer 110 may depend on the concentration of the developer 200.

At this point, the production of the color filter substrate 10 of the embodiment is completed. By the aforementioned process steps, in addition to simplifying the current manufacturing process of color filter substrates, the variety of materials used may also be reduced. On the other hand, the integration of the first protruding portion 110pp1, the second protruding portion 110pp2 and the flat portion 110fp into one piece may also make the connection between the protruding portions and the flat portion 110fp less susceptible to damage from external forces.

Furthermore, in the embodiment, the aforementioned overcoat material layer 110M is, for example, a negative photoresist, but the disclosure is not limited thereto. In another modified embodiment, the overcoat material layer 110M may also be a positive photoresist. Therefore, the distribution of the light-transmitting area and the light-shielding area of the mask used in the exposure process is opposite to that of the mask MSK in the embodiment. For example: in the modified embodiment, the first light-transmitting area LTA1 and the light-shielding area LSA in the embodiment will be respectively adjusted to the light-shielding area LSA and the first light-transmitting area LTA1.

Some other embodiments are provided below to describe the invention in detail, where the same reference numerals denote the same or like components, and descriptions of the same technical contents are omitted. The aforementioned embodiment may be referred for descriptions of the omitted parts, and detailed descriptions thereof are not repeated in the following embodiment.

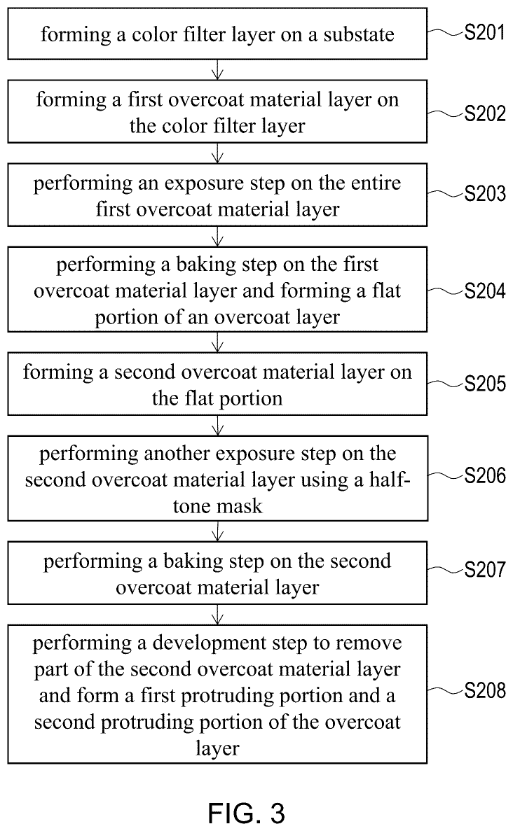

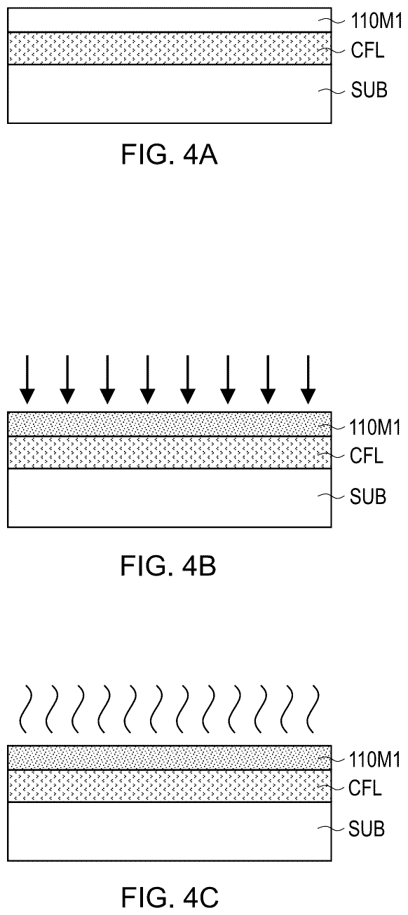

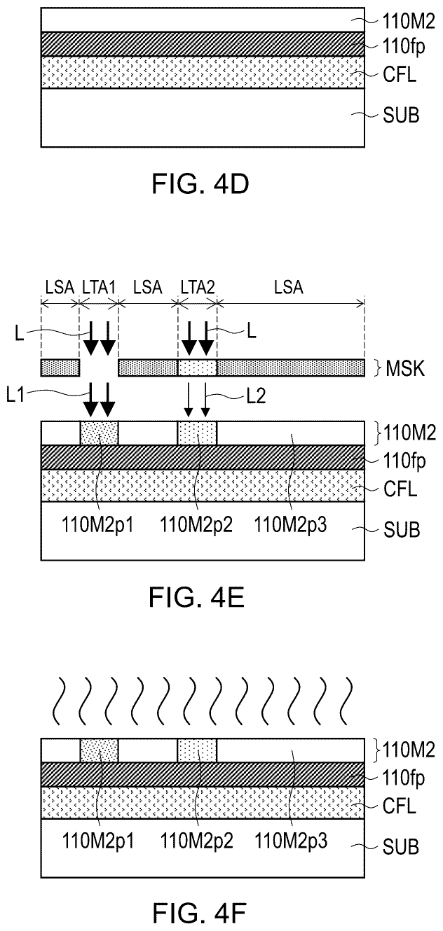

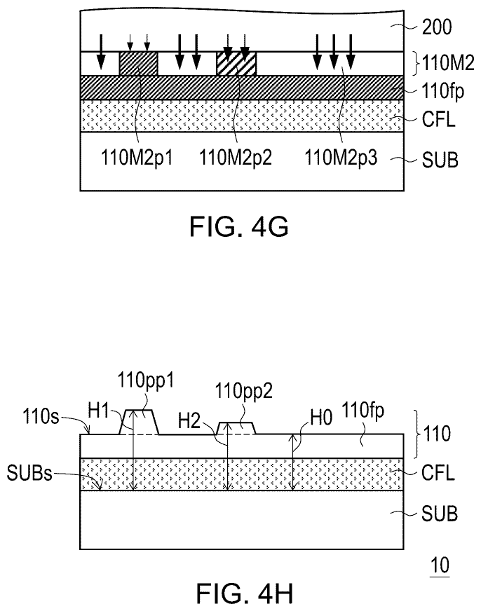

FIG. 3 is a flow chart of a method of fabricating a color filter substrate according to a second embodiment of the disclosure. FIGS. 4A to 4H are schematic cross-sectional views of a method of fabricating a color filter substrate according to a second embodiment of the disclosure. Firstly, it should be noted that since the color filter substrate 10 in FIG. 4H is the same as the color filter substrate 10 in FIG. 2F, detailed descriptions of its structural composition and configuration can be found in the relevant paragraphs of the aforementioned embodiment and will not be repeated here.

Referring to FIG. 3, the embodiment will demonstrate a second method of fabricating the color filter substrate 10. More specifically, in the embodiment, the coating, exposure process and baking process of the overcoat material layer can be divided into two stages. The second method of fabricating the color filter substrate 10 will be exemplarily described below.

First, forming a color filter layer CFL (i.e., step S201) and a first overcoat material layer 110M1 (i.e., step S202) sequentially on a substrate SUB, as shown in FIG. 4A. Next, performing an exposure step on the entire first overcoat material layer 110M1 (i.e., step S203), as shown in FIG. 3 and FIG. 4B. After completion, performing a baking step on the first overcoat material layer 110M1, and forming a flat portion 110fp of an overcoat layer 110 (i.e., step S204), as shown in FIG. 3, FIG. 4C, and FIG. 4D. That is to say, after a first stage of the exposure process and the baking process are completed, the first overcoat material layer 110M1 has a high curing rate.

Referring to FIG. 3 and FIG. 4D, next, forming a second overcoat material layer 110M2 on the flat portion 110fp (i.e., step S205). After completion, performing another exposure step on the second overcoat material layer 110M2 using a mask MSK (i.e., step S206), as shown in FIG. 3 and FIG. 4E. Since the mask MSK in the embodiment is similar to the mask MSK in FIG. 2C, relevant descriptions can be found in the relevant paragraphs of the foregoing embodiment and will not be repeated here.

After the exposure step of the second overcoat material layer 110M2 is completed, the portion 110M2p1 of the second overcoat material layer 110M2 irradiated by the light ray L1 (i.e., the portion overlapping the first light-transmitting area LTA1 of the mask MSK) will have higher degree of cure than the portion 110M2p2 of the second overcoat material layer 110M2 irradiated by the light ray L2 (i.e., the portion overlapping the second light-transmitting area LTA2 of the mask MSK), and the portion 110M2p3 of the second overcoat material layer 110M2 that is not irradiated by the light ray (i.e., the portion overlapping the light-shielding area LSA of the mask MSK) will not be substantially cured.

Referring to FIG. 3 and FIG. 4F, next, performing a baking step on the second overcoat material layer 110M2 (i.e., step S207). During the baking process, the overall material bonding strength of the second overcoat material layer 110M2 may be further improved. Next, performing a development step to remove part of the second overcoat material layer 110M2, and form a first protruding portion 110pp1 and a second protruding portion 110pp2 of the overcoat layer 110 (i.e., step S208), as shown in FIG. 3, FIG. 4G and FIG. 4H. Since the development process in FIG. 4G is similar to the development process in FIG. 2E, relevant descriptions can be found in the relevant paragraphs of the foregoing embodiment and will not be repeated here.

At this point, the description of the second method of fabricating the color filter substrate 10 is completed. By the aforementioned process steps, in addition to simplifying the current manufacturing process of color filter substrates, the variety of materials used may also be reduced. On the other hand, the integration of the first protruding portion 110pp1, the second protruding portion 110pp2 and the flat portion 110fp into one piece may also make the connection between the protruding portions and the flat portion 110fp less susceptible to damage from external forces.

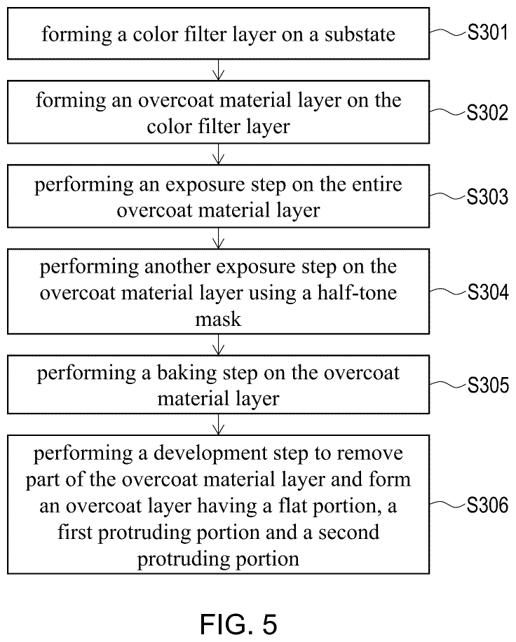

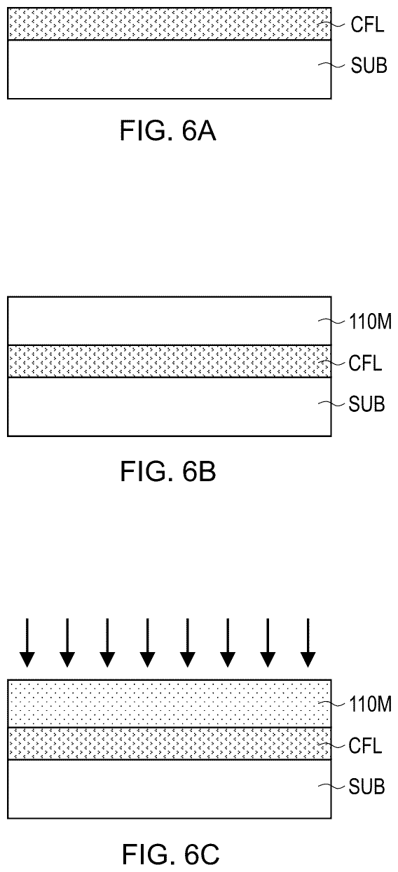

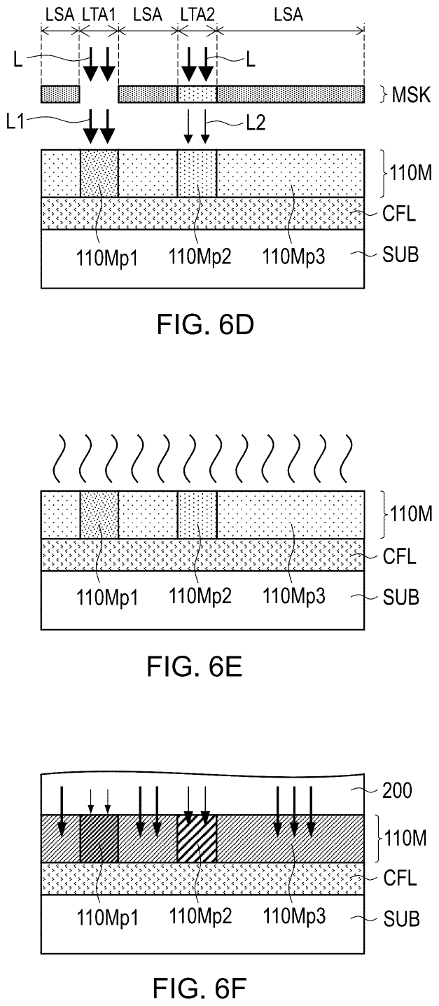

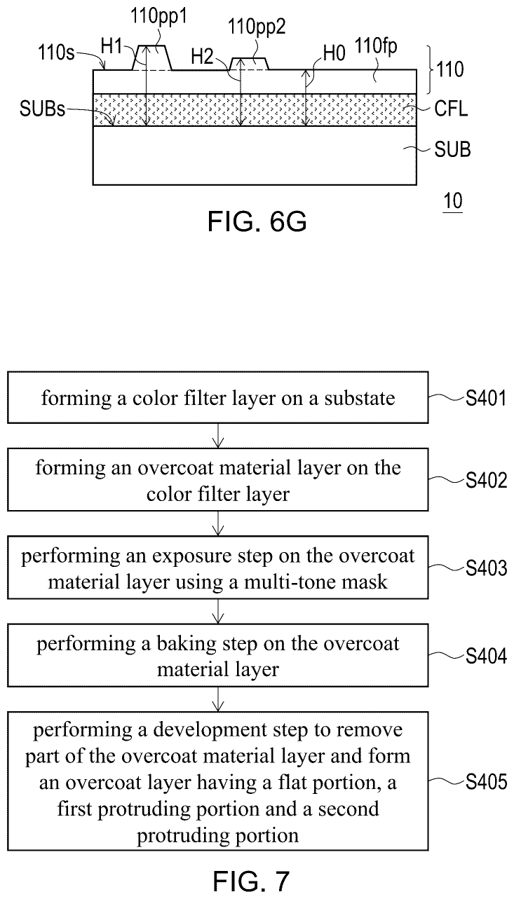

FIG. 5 is a flow chart of a method of fabricating a color filter substrate according to a third embodiment of the disclosure. FIGS. 6A to 6G are schematic cross-sectional views of a method of fabricating a color filter substrate according to a third embodiment of the disclosure. Firstly, it should be noted that since the color filter substrate 10 of FIG. 6G is the same as the color filter substrate 10 of FIG. 2F, detailed descriptions of its structural composition and configuration can be found in the relevant paragraphs of the aforementioned embodiments and will not be repeated here.

Referring to FIG. 5, the embodiment will demonstrate a third method of fabricating the color filter substrate 10. More specifically, in the embodiment, the exposure process of the overcoat material layer can be divided into two stages. The third method of fabricating the color filter substrate 10 will be exemplarily described below.

Referring to FIG. 5 and FIG. 6A, first, forming a color filter layer CFL on a substrate SUB (i.e., step S301). Next, forming an overcoat material layer 110M on the color filter layer CFL (i.e., step S302), as shown in FIG. 6B. Specifically, in the embodiment, the thickness of the overcoat material layer 110M is greater than the sum of the thicknesses of the first protruding portion 110pp1 and the flat portion 110fp in FIG. 6G. The thickness referred to here, for example, is the thickness of film layer along the stacking direction of the substrate SUB and the color filter layer CFL. More specifically, in the method of fabricating the color filter substrate 10 of the embodiment, the step of forming the overcoat material layer 110M may be a one-time coating method, but the disclosure is not limited thereto.

Referring to FIG. 5, FIG. 6C and FIG. 6D, after the film formation of the overcoat material layer 110M, performing an exposure step of a first stage on the entire overcoat material layer 110M (i.e., step S303). After completion, performing an exposure step of a second stage on the overcoat material layer 110M using a mask MSK (i.e., step S304). Since the mask MSK and the exposure process (second stage) in FIG. 6D are similar to the mask MSK and the exposure process in FIG. 2C, relevant descriptions can be found in the relevant paragraphs of the foregoing embodiment and will not be repeated here.

Specifically, the exposure intensity used by an exposure light source in the exposure process of the first stage will be lower than the exposure intensity used in the exposure process of the second stage. For example, in the exposure process of the first stage, the entire overcoat material layer 110M may be weakly exposed at a relatively low exposure intensity to slightly change the bonding state of the material. That is to say, in this stage of exposure, the exposure amount received by each portion of the overcoat material layer 110M is substantially the same.

After the exposure step of the second stage is completed, the portion 110Mp1 of the overcoat material layer 110M overlapping the first light-transmitting area LTA1 of the mask MSK has the highest degree of cure due to receiving the highest amount of exposure (contributed by the two stages of exposure). The portion 110Mp2 of the overcoat material layer 110M overlapping the second light-transmitting area LTA2 of the mask MSK has the second highest degree of cure due to receiving the second highest amount of exposure (contributed by the two stages of exposure). The portion 110Mp3 of the overcoat material layer 110M overlapping the light-shielding area LSA of the mask MSK has the lowest degree of cure due to receiving the least amount of exposure (contributed only by the first stage of exposure).

Referring to FIG. 5 and FIG. 6E, after the exposure steps of the two stages of the overcoat material layer 110M, performing a baking step on the overcoat material layer 110M (i.e., step S305). During the baking process, the overall material bonding strength of the overcoat material layer 110M may be further improved. Next, performing a development step to remove part of the overcoat material layer 110M, and form an overcoat layer 110 having a flat portion 110fp, a first protruding portion 110pp1 and a second protruding portion 110pp2 (i.e., step S306), as shown in FIG. 6F and FIG. 6G. Since the development process in FIG. 6F is similar to the development process in FIG. 2E, relevant descriptions can be found in the relevant paragraphs of the foregoing embodiment and will not be repeated here.

At this point, the description of the third method of fabricating the color filter substrate 10 is completed. By the aforementioned process steps, in addition to simplifying the current manufacturing process of color filter substrates, the variety of materials used may also be reduced. On the other hand, the integration of the first protruding portion 110pp1, the second protruding portion 110pp2 and the flat portion 110fp into one piece may also make the connection between the protruding portions and the flat portion 110fp less susceptible to damage from external forces.

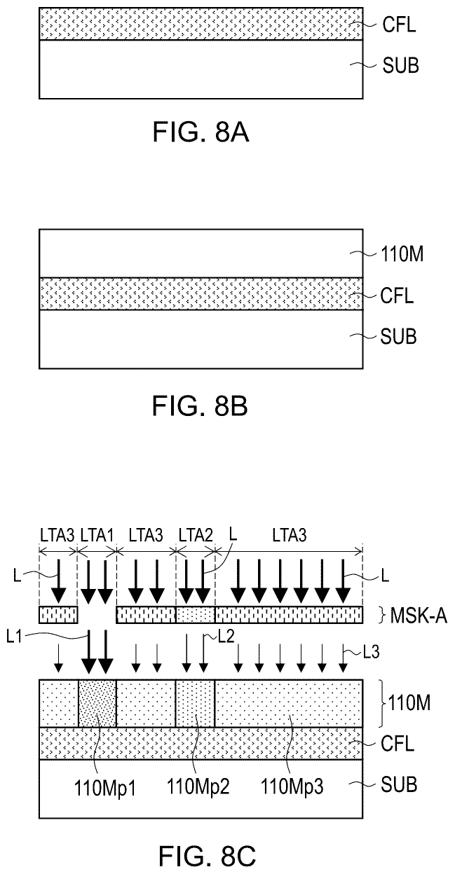

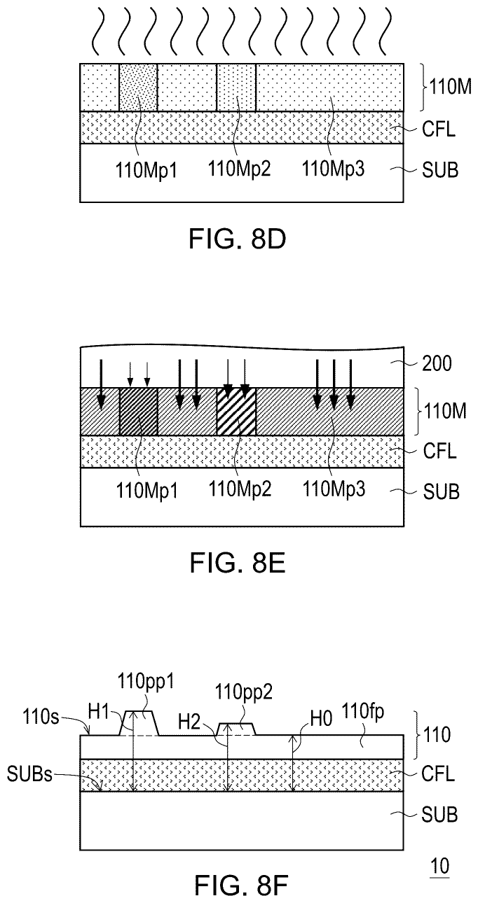

FIG. 7 is a flow chart of a method of fabricating a color filter substrate according to a fourth embodiment of the disclosure. FIGS. 8A to 8F are schematic cross-sectional views of a method of fabricating a color filter substrate according to a fourth embodiment of the disclosure. Firstly, it should be noted that since the color filter substrate 10 of FIG. 8F is the same as the color filter substrate 10 of FIG. 2F, detailed descriptions of its structural composition and configuration can be found in the relevant paragraphs of the aforementioned embodiments and will not be repeated here.

Referring to FIG. 7, the embodiment will demonstrate a fourth method of fabricating the

color filter substrate 10. It should be noted that, in the embodiment, the mask used in the exposure process is, for example, a multi-tone mask. The fourth method of fabricating the color filter substrate 10 will be exemplarily described below.

Referring to FIG. 7 and FIG. 8A, first, forming a color filter layer CFL on a substrate SUB (i.e., step S401). Next, forming an overcoat material layer 110M on the color filter layer CFL (i.e., step S402), as shown in FIG. 8B. Specifically, in the embodiment, the thickness of the overcoat material layer 110M is greater than the sum of the thicknesses of the first protruding portion 110pp1 and the flat portion 110fp in FIG. 8F. The thickness referred to here, for example, is the thickness of film layer along the stacking direction of the substrate SUB and the color filter layer CFL. More specifically, in the method of fabricating the color filter substrate 10 of the embodiment, the step of forming the overcoat material layer 110M may be a one-time coating method, but the disclosure is not limited thereto.

Referring to FIG. 7 and FIG. 8C, after the film formation of the overcoat material layer 110M, performing an exposure step on the overcoat material layer 110M using a mask MSK-A (i.e., step S403). In the embodiment, the mask MSK-A is, for example, a multi-tone mask, which may have a first light-transmitting area LTA1, a second light-transmitting area LTA2, and a third light-transmitting area LTA3 outside the first light-transmitting area LTA1 and the second light-transmitting area LTA2. For example, the transmittance of the second light-transmitting area LTA2 is less than the transmittance of the first light-transmitting area LTA1 and greater than the transmittance of the third light-transmitting area LTA3. Therefore, during the exposure process, the multiple light rays L emitted by an exposure light source form a light ray L1, a light ray L2 and a light ray L3 with different light intensities after respectively passing through the first light-transmitting area LTA1, the second light-transmitting area LTA2 and the third light-transmitting area LTA3 of the mask MSK-A. For example, after passing through the mask MSK-A, the light intensity of the light ray L1 is greater than the light intensity of the light ray L2, and the light intensity of the light ray L2 is greater than the light intensity of the light ray L3.

After the exposure step is completed, the portion 110Mp2 of the overcoat material layer 110M irradiated by the light ray L2 (i.e., the portion overlapping the second light-transmitting area LTA2 of the mask MSK-A) will have a lower degree of cure than the portion 110Mp1 of the overcoat material layer 110M irradiated by the light ray L1 (i.e., the portion overlapping the first light-transmitting area LTA1 of the mask MSK-A), but a higher degree of cure than the portion 110Mp3 of the overcoat material layer 110M irradiated by the light ray L3 (i.e., the portion overlapping the third light-transmitting area LTA3 of the mask MSK-A).

Referring to FIG. 7 and FIG. 8D, after the exposure step of the overcoat material layer 110M, performing a baking step on the overcoat material layer 110M (i.e., step S404). During the baking process, the overall material bonding strength of the overcoat material layer 110M may be further improved. Next, performing a developing step to remove part of the overcoat material layer 110M, and form an overcoat layer 110 having a flat portion 110fp, a first protruding portion 110pp1 and a second protruding portion 110pp2 (i.e., step S405), as shown in FIG. 8E and FIG. 8F. Since the development process in FIG. 8E is similar to the development process in FIG. 2E, relevant descriptions can be found in the relevant paragraphs of the foregoing embodiments and will not be repeated here.

It is particularly noted that in the embodiment, the flat portion 110fp of the overcoat layer 110 in FIG. 8F is formed after developing the portion 110Mp3 of the overcoat material layer 110M in FIG. 8C overlapping the third light-transmitting area LTA3 of the mask MSK-A.

At this point, the description of the fourth method of fabricating the color filter substrate 10 is completed. By the aforementioned process steps, in addition to simplifying the current manufacturing process of color filter substrates, the variety of materials used may also be reduced. On the other hand, the integration of the first protruding portion 110pp1, the second protruding portion 110pp2 and the flat portion 110fp into one piece may also make the connection between the protruding portions and the flat portion 110fp less susceptible to damage from external forces.

To sum up, in a method of fabricating a color filter substrate according to an embodiment of the disclosure, an exposure step using a mask having at least two light-transmitting areas is performed on one of the at least one overcoat material layer formed on a color filter layer, and an overcoat layer having multiple portions of different heights is formed after a development step. Accordingly, in addition to simplifying the manufacture process of the color filter substrate, the variety of materials used may be reduced. The multiple portions of the produced overcoat layer with different heights may fulfill various functional requirements and are less susceptible to damage from external forces.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method of fabricating a color filter substrate, comprising:
forming a color filter layer on a substrate;
forming at least one overcoat material layer on the color filter layer;
performing an exposure step on the at least one overcoat material layer using a mask, wherein the mask has a first light-transmitting area and a second light-transmitting area, and a transmittance of the first light-transmitting area is greater than a transmittance of the second light-transmitting area; and
performing a development step to remove part of the at least one overcoat material layer and form an overcoat layer having a flat portion, a first protruding portion and a second protruding portion, wherein the flat portion, the first protruding portion and the second protruding portion of the overcoat layer respectively have different heights relative to a substrate surface of the substrate.

2. The method of fabricating the color filter substrate according to claim 1, wherein the at least one overcoat material layer is an overcoat material layer, the mask further has a light-shielding area in addition to the first light-transmitting area and the second light-transmitting area, the overcoat material layer has a portion overlapping the light-shielding area, and the portion of the overcoat material layer forms the flat portion after the exposure step and the development step are completed.

3. The method of fabricating the color filter substrate according to claim 2, further comprising:
performing a baking step on the overcoat material layer after the exposure step and before the development step.

4. The method of fabricating the color filter substrate according to claim 2, further comprising:
performing another exposure step on the entire overcoat material layer before performing the exposure step on the overcoat material layer using the mask, wherein the exposure intensity of the another exposure step is lower than the exposure intensity of the exposure step.

5. The method of fabricating the color filter substrate according to claim 4, further comprising:
performing a baking step on the overcoat material layer after the exposure step and the another exposure step are completed.

6. The method of fabricating the color filter substrate according to claim 1, wherein the step of forming the at least one overcoat material layer includes:
forming a first overcoat material layer on the color filter layer, and the method of fabricating the color filter substrate further includes performing another exposure step on the entire first overcoat material layer to form the flat portion.

7. The method of fabricating the color filter substrate according to claim 6, wherein the step of forming the at least one overcoat material layer further includes:
forming a second overcoat material layer on the flat portion after the another exposure step is completed, and the second overcoat material layer forms the first protruding portion and the second protruding portion after the exposure step and the development step.

8. The method of fabricating the color filter substrate according to claim 7, wherein a baking step is performed on the first overcoat material layer after the another exposure step is completed and before the second overcoat material layer is formed.

9. The method of fabricating the color filter substrate according to claim 1, wherein the at least one overcoat material layer is an overcoat material layer, the mask further has a third light-transmitting area, a transmittance of the third light-transmitting area is less than the transmittance of the first light-transmitting area and the transmittance of the second light-transmitting area, the overcoat material layer has a portion overlapping the third light-transmitting area, the portion of the overcoat material layer forms the flat portion of the overcoat layer after the exposure step and the development step are completed.

10. The method of fabricating the color filter substrate according to claim 1, wherein the at least one overcoat material layer is a negative photoresist.
